(19) United States
(12) Patent Application Publication
(10) Pub. No.: US 2019/0313026 A1
(43) Pub. Date: Oct. 10, 2019

(54) MULTI-CONTEXT REAL TIME INLINE IMAGE SIGNAL PROCESSING

(71) Applicant: QUALCOMM Incorporated, San Diego, CA (US)

(72) Inventors: Scott Cheng, Foothill Ranch, CA (US); Chih-Chi Cheng, Santa Clara, CA (US); Pawan Kumar Baheti, Bangalore (IN); Michael Lee Coulter, San Diego, CA (US); Maulesh Patel, San Diego, CA (US); John Welch, Encinitas, CA (US); Krishnam Indukuri, San Diego, CA (US)

(21) Appl. No.: 15/948,628

(22) Filed: Apr. 9, 2018

(51) Int. Cl. H04N 5/232; G06T 1/20; H04J 3/14; G06T 1/60; G06T 7/00; H04N 5/225

(52) U.S. Cl. CPC H04N 5/23245; G06T 1/20; H04N 5/2258; G06T 1/60; G06T 7/00; H04J 3/14

(57) ABSTRACT

Methods, systems, and devices for image processing are described. A device may include a plurality of buffer components, each of which may receive a pixel lines that may each be associated with a respective raw image. An arbitration component of the device may combine at least some of the pixel lines into one or more data packets. The arbitration component may pass, using an arbitration scheme such as a time division multiplexing scheme, the one or more data packets from the arbitration component to a shared image signal processor (ISP) of the device. The shared ISP may generate a respective processed image based at least in part on the one or more data packets. In some examples, the device may maintain a respective set of image statistics, registers, and the like for at least some of the raw images.

### BACKGROUND

The following relates generally to image processing, and more specifically to multi-context real time inline image signal processing.

Some devices (e.g., mobile devices, vehicles) may have multiple sensors (e.g., one front-facing camera and one rear-facing camera) and/or sensors which may operate in multiple modes (e.g., where each different sensor and/or mode of a given sensor may be associated with a different focal length, aperture size, stability control). As an example, some motor vehicles may have multiple (e.g., twelve) sensors, which may all be supported by a given die (e.g., such that the die may be manufactured to support a large number of sensors). As the number of sensors increases, the processing required to handle output from the sensors may grow. For example, the increased number of sensors may be associated with an increased number of image processing engines (e.g., which may be limited by the area of the die, the processing power capabilities of the device) Improved techniques for multi-context image signal processing may be desired.

### SUMMARY

The described techniques relate to improved methods, systems, devices, and apparatuses that support multi-context real time inline image signal processing. Generally, the described techniques provide for a shared multi-context image signal processor (ISP) and related operational considerations. In accordance with the described techniques, a single data path (e.g., a display serial interface (DSI)) may be shared between incoming data from multiple sensors or different modes of a same sensor. For example, the multi-context ISP may buffer the incoming data into input buffers. Once a line of data is available, an arbitration component may arbitrate amongst buffers for processing through the data path (e.g., through the multi-context ISP) using one or more sharing techniques, such as time-division multiplexing. Each context may include its own set of software-configurable registers, statistics storages, and line buffer storages. Such an architecture may, for example, support scalability across different mobile tiers, support more flexibility in sensor permutations, improve picture quality for each sensor (e.g., compared to a shared single-context ISP), and/or provide other such benefits.

A method of image processing at a device is described. The method may include receiving, at each of a set of buffer components of the device, respective sets of pixel lines, where each set of pixel lines is associated with a respective raw image, combining, by an arbitration component, each set of pixel lines into one or more data packets, passing, using a time division multiplexing scheme, the one or more data packets from the arbitration component to a shared ISP of the device, and generating, by the shared ISP, a respective processed image for each raw image based on the one or more data packets.

An apparatus for image processing at a device is described. The apparatus may include a processor, memory in electronic communication with the processor, and instructions stored in the memory. The instructions may be executable by the processor to cause the apparatus to receive, at each of a set of buffer components of the device, respective sets of pixel lines, where each set of pixel lines is associated with a respective raw image, combine, by an arbitration component, each set of pixel lines into one or more data packets, pass, using a time division multiplexing scheme, the one or more data packets from the arbitration component to a shared ISP of the device, and generate, by the shared ISP, a respective processed image for each raw image based on the one or more data packets.

Another apparatus for image processing at a device is described. The apparatus may include means for receiving, at each of a set of buffer components of the device, respective sets of pixel lines, where each set of pixel lines is associated with a respective raw image, means for combining, by an arbitration component, each set of pixel lines into one or more data packets, means for passing, using a time division multiplexing scheme, the one or more data packets from the arbitration component to a shared ISP of the device, and means for generating, by the shared ISP, a respective processed image for each raw image based on the one or more data packets.

Some examples of the method and apparatuses described herein may further include operations, features, means, or instructions for determining an arbitration metric for passing the one or more data packets to the shared ISP, where the arbitration metric includes a latency metric for each respective raw image, a size of each respective raw image, an imaging condition for each respective raw image, a buffer component size for each respective raw image, a resolution for each respective raw image, or a combination thereof and determining an arbitration scheme for the one or more data packets based on the arbitration metric, where using the time division multiplexing scheme includes implementing the arbitration scheme for the one or more data packets.

Some examples of the method and apparatuses described herein may further include operations, features, means, or instructions for determining one or more image statistics for each raw image, passing the one or more image statistics to the shared ISP based on the time division multiplexing scheme and updating one or more image processing parameters of the shared ISP for each data packet associated with a given raw image, where generating the respective processed image for each raw image may be based on the updated one or more image processing parameters.

Some examples of the method and apparatuses described herein may further include operations, features, means, or instructions for capturing each raw image at a respective sensor of the device, where each sensor may be associated with a respective buffer component of the set of buffer components.

Some examples of the method and apparatuses described herein may further include operations, features, means, or instructions for identifying a first imaging condition associated with a first sensor mode, capturing a first raw image at a first sensor of the device using the first sensor mode based on the first imaging condition, where a first buffer component of the set of buffer components may be associated with the first sensor, identifying a second imaging context associated with a second sensor mode and capturing a second raw image at a second sensor of the device using the second sensor mode, where a second buffer component of the set of buffer components may be associated with the second sensor.

In some examples of the method and apparatuses described herein, the first sensor and the second sensor include a same sensor of the device, the same sensor configured to capture the first raw image using the first sensor mode at a first time based on the first imaging condition and configured to capture the second raw image using the second sensor mode at a second time based on the second imaging condition.

In some examples of the method and apparatuses described herein, the first imaging condition and the second imaging condition each include one or more of a lighting condition, a focal length, a frame rate, an aperture width, or a combination thereof.

Some examples of the method and apparatuses described herein may further include operations, features, means, or instructions for identifying a pixel throughput limit for a line buffer of the shared ISP, determining a respective pixel performance metric for each sensor of a set of sensors coupled with the device and configuring a space allocation of the line buffer based on the pixel performance metrics, a number of sensors in the set of sensors, or a combination thereof.

In some examples of the method and apparatuses described herein, configuring the space allocation of the line buffer of the shared ISP includes allocating respective subspaces of the line buffer the one or more data packets from the arbitration component based on the pixel performance metrics.

Some examples of the method and apparatuses described herein may further include operations, features, means, or instructions for updating values of a respective register for each of the set of buffer components, where the respective processed image for each raw image may be generated based on the updated values of the respective register.

Some examples of the method and apparatuses described herein may further include operations, features, means, or instructions for writing at least one processed image to a memory of the device, transmitting the at least one processed image to a second device, displaying the at least one processed image, or updating an operating parameter of the device based on the at least one processed image.

### BRIEF DESCRIPTION OF THE DRAWINGS

FIG. 1 illustrates an example of a device that supports multi-context real time inline image signal processing in accordance with aspects of the present disclosure.

FIG. 2 illustrates an example of a system that supports multi-context real time inline image signal processing in accordance with aspects of the present disclosure.

FIG. 3 illustrates an example of a process flow that supports multi-context real time inline image signal processing in accordance with aspects of the present disclosure.

FIG. 4 illustrates an example of a timing diagram that supports multi-context real time inline image signal processing in accordance with aspects of the present disclosure.

FIG. 5 shows a block diagram of a device that supports multi-context real time inline image signal processing in accordance with aspects of the present disclosure.

FIG. 6 shows a diagram of a system including a device that supports multi-context real time inline image signal processing in accordance with aspects of the present disclosure.

FIGS. 7 through 11 show flowcharts illustrating methods that support multi-context real time inline image signal processing in accordance with aspects of the present disclosure.

### DETAILED DESCRIPTION

Some devices (e.g., mobile devices, vehicles) may have multiple sensors and/or sensors which may operate in multiple modes. Aspects of the present disclosure relate to a shared multi-context ISP. For example, the multi-context ISP may support dynamic multi-mode switching for sensors of a device (e.g., in which a given sensor may switch from one mode to another mode, such as switching from short exposures to long exposures, based on some imaging condition). The described techniques relate to a real-time inline ISP engine that supports multiple pixel streams across one or more mobile industry processor interfaces (MIPIs) from multiple sensors. In some examples, as long as the combined pixel performance of all sensors concurrently operating does not exceed the ISP pixel/second performance, the single ISP may support one or more sensors (e.g., each with various frame rates and resolutions). As an example, a single one pixel per clock cycle ISP running at 750 MHz in accordance with aspects of the present disclosure may support a 5 mega-pixel (MP) sensor operating at 30 frames-per-second (fps), an 8 MP sensor operating at 60 fps, and a 12 MP sensor operating at 10 fps.

Aspects of the disclosure are initially described in the context of a device, process flows, and a timing diagram. Aspects of the disclosure are further illustrated by and described with reference to apparatus diagrams, system diagrams, and flowcharts that relate to multi-context real time inline image signal processing.

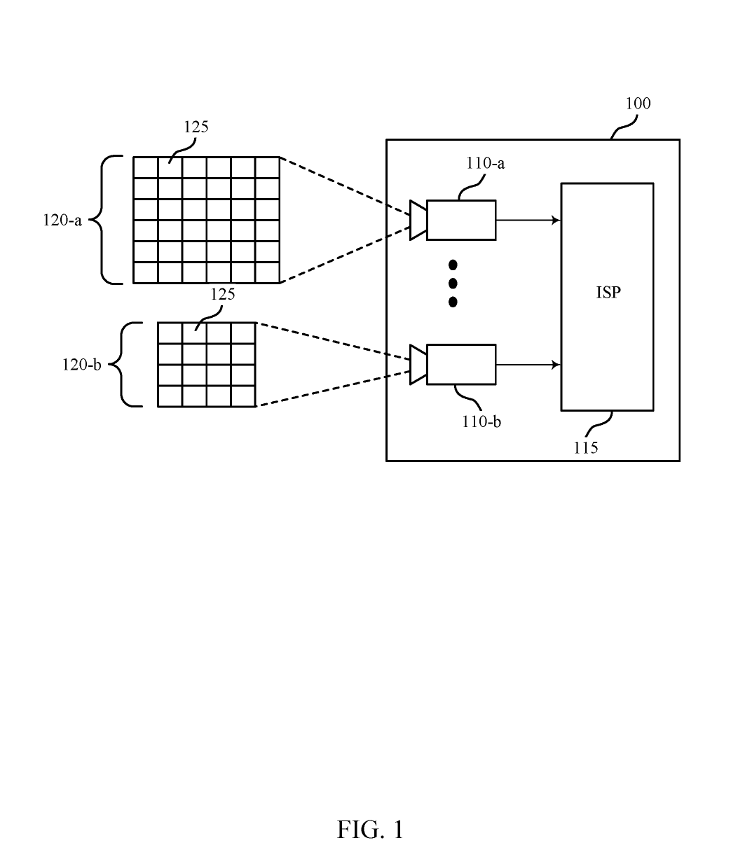

FIG. 1 illustrates an example of a device 100 that supports multi-context real time inline image signal processing in accordance with aspects of the present disclosure. For example, device 100 may be an example of a mobile device or a device used in a mobile environment (e.g., a vehicle). A mobile device may also be referred to as a user equipment (UE), a wireless device, a remote device, a handheld device, or a subscriber device, or some other suitable terminology, where the “device” may also be referred to as a unit, a station, a terminal, or a client. A mobile device may be a personal electronic device such as a cellular phone, a personal digital assistant (PDA), a tablet computer, a laptop computer, or a personal computer. In some examples, a mobile device may also refer to a wireless local loop (WLL) station, an Internet of Things (IoT) device, an Internet of Everything (IoE) device, a machine type communication (MTC) device, or the like, which may be implemented in various articles such as appliances, vehicles, meters, or some other suitable terminology. In some cases, mobile device may be used to refer to a vehicle (e.g., an automobile) or a component of a vehicle such that mobile device may refer to the transitory nature of the device without necessarily conveying a size limitation or an intended use (e.g., wireless communications).

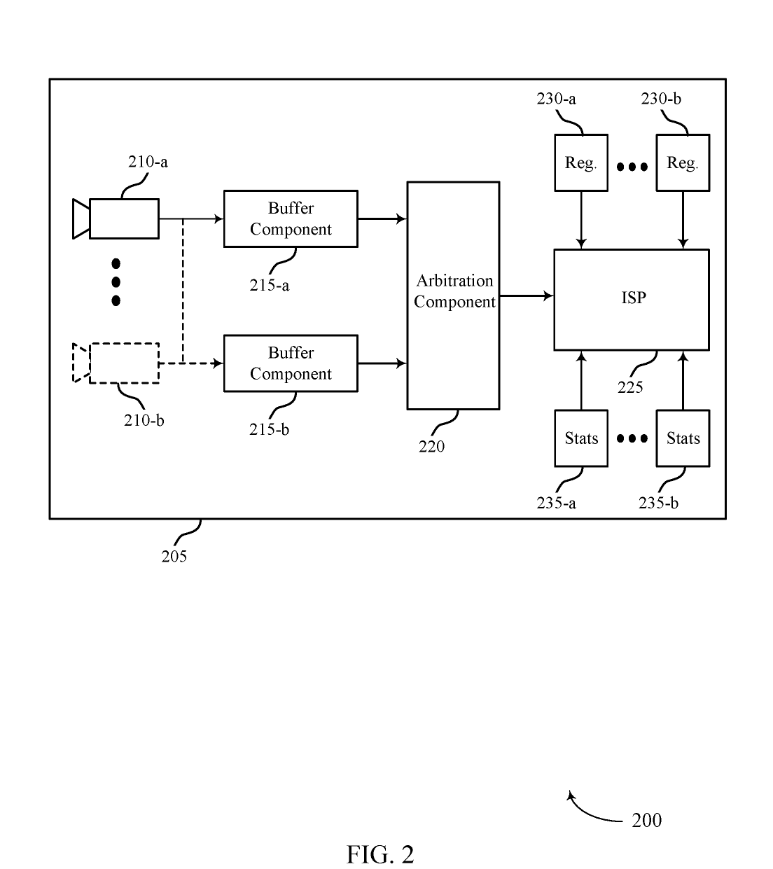

Device 100 may, in some examples, contain multiple sensors 110 or a single sensor 110 that is capable of operation in multiple modes. That is, though illustrated as separate sensors 110, in some cases sensor 110-a and sensor 110-b may each represent sensors that are able to operate in one or more different operational modes (related to a set of hardware components) as described further with reference to FIG. 2.

Sensor 110-a may capture first raw image 120-a (e.g., which may be represented as an array of pixels 125). Similarly, sensor 110-b may capture second raw image 120-b (e.g., which may be represented as an array of pixels 125). Each raw image 120 may comprise a digital representation of a respective scene. As illustrated, sensor 110-a and sensor 110-b may, in some examples, differ in terms of resolution (e.g., in terms of the number of pixels 125 in each raw image 120) or other characteristics. Additionally or alternatively, sensor 110-a and sensor 110-b may differ in terms of frame rate, aperture width, or other such operating parameters. Though described in the context of two sensors 110, it is to be understood that the described techniques may apply to any suitable number of sensors 110 (e.g., more than two sensors).

In some alternative examples, each sensor 110 may be associated with a different, respective processing engine (e.g., a respective ISP 115). Such a design may enable increase flexibility and support different sensor types, frame rates, and resolutions. However, such a design may be neither area-efficient (e.g., in terms of system-on-a-chip (SoC) production) nor competitive in terms of power consumption. Aspects of the present disclosure may be used to allow the number of sensors 110 to increase without the need to add additional ISP engines for each respective sensor while also allowing for additional capabilities and techniques.

An alternative to such a multi-core (e.g., multi-engine) ISP architecture described above may be writing out sensor image data to off-chip memory. An offline ISP engine may then read each image back from double data rate (DDR) memory one-by-one. Such an architecture may be associated with high bandwidth between the sensor 110 and DDR memory (e.g., which may in turn be associated with increased power consumption). These constraints (e.g., as well as the latency incurred by such a solution) may limit the applicability of such an architecture in some markets (e.g., for mobile devices) and may have other aspects that different from a shared ISP example, as described herein.

Another architecture may address such concerns by merging images from multiple sensors 110 into a single stream, which may then be processed through a single ISP 115. Such a solution may, for example, address aspects of the latency and high-bandwidth limitations discussed for the architectures above. However, this architecture may be associated with lower image quality (e.g., because image statistics may not be independently controlled or configured). Additionally, such an architecture may be associated with complications in terms of different sensor types (e.g., different frame rates, different resolutions).

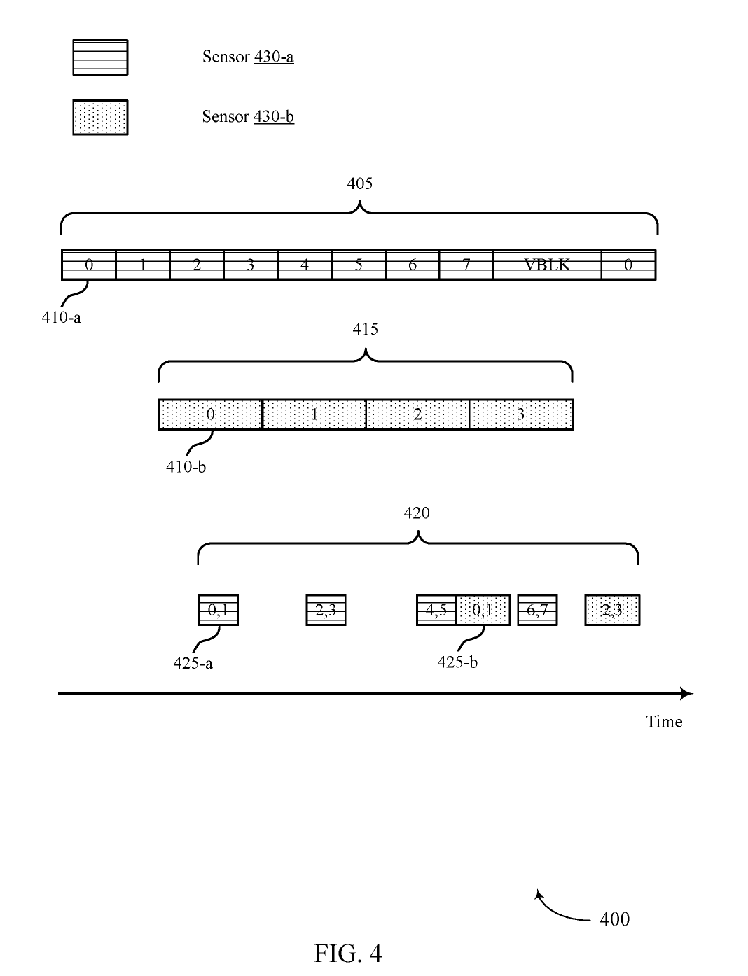

In accordance with aspects of the present disclosure, each of sensor 110-a and sensor 110-b may pass data representing one or more respective raw images 120-a and 120-b to a shared ISP 115 (e.g., an ISP engine having hardware components that are configurable to switch between contexts based on input image statistics with little or no latency). For example, device 100 may include an arbitration component (e.g., as described with reference to FIG. 2), which may multiplex one or more sections of an image or lines (e.g., rows) of pixels 125 from raw images 120-a and 120-b to ISP 115 (e.g., as described with reference to FIG. 4). In aspects of the following, device 100 may support respective registers, image statistics, and the like for each of sensor 110-a and sensor 110-b which may improve the quality of the processed images corresponding to raw images 120-a and 120-b.

FIG. 2 illustrates an example of a process flow 200 that supports multi-context real time inline image signal processing in accordance with aspects of the present disclosure. Process flow 200 illustrates operations of a device 205, which may be an example of device 100 (e.g., a mobile device, a vehicle, an IoT device).

Device 205 may include sensor 210-a (e.g., which may be an example of a sensor 110 as described with reference to FIG. 1). In some cases, device 205 may include at least a second sensor 210-b. Additionally or alternatively, sensor 210-a may support multi-mode operation (e.g., such that sensor 210-b in aspects of the present disclosure may refer to a virtual sensor that shares hardware components with sensor 210-a, or sensor 210-a may be operable to operate in a first mode and a second mode that is different from the first mode). It is to be understood that device 205 may include more than two sensors 210 and in some cases each sensor 210 may be operable to operate in at least two modes. Thus, sensor 210-a and sensor 210-b are illustrated and described for the sake of explanation and are not necessarily limiting of scope.

By way of example, device 205 may select between sensor 210-a and sensor 210-b based on an imaging condition (e.g., a lighting condition, a focal length, a frame rate, an aperture width, a motion analysis, a combination thereof). In some cases, device 205 may support concurrent (e.g., or at least partially concurrent) operation of sensor 210-a and sensor 210-b. By way of example, a vehicle may perform operations (e.g., a lane change, an acceleration, etc.) based on analysis of front-facing images (e.g., from or associated with sensor 210-a) and rear-facing images (e.g., from or associated with sensor 210-b). Image data from sensor 210-a may be fed to buffer component 215-a while image data from sensor 210-b may be fed to buffer component 215-b. As described above, sensor 210-a and sensor 210-b may in some cases be associated with different operational modes of a single physical sensor (e.g., such that the image data for buffer component 215-b may instead in some cases originate at sensor 210-a such that sensor 210-a originates data fed to buffer component 215-a and buffer component 215-b). In accordance with the described techniques, each buffer component 215 may feed image data (e.g., rows of pixels) to an arbitration component 220.

In some examples, arbitration component 220 may implement an arbitration scheme (e.g., a time-division multiplexing scheme) for passing data packets to a shared ISP 225 (e.g., where each data packet may include one or more rows of pixels associated with a given buffer component 215). For example, arbitration component 220 may determine an arbitration metric for passing the data packets to the shared ISP 225. Examples of such arbitration metrics include a latency metric for each raw image, a size of each raw image, an imaging condition for each raw image, a buffer component 215 size for each raw image, a resolution for each raw image, or a combination thereof. Arbitration component 220 may determine an arbitration scheme (e.g., as described with reference to FIG. 4) based on the one or more arbitration metrics, among other factors. As an example, arbitration component 220 may determine that a frame rate for sensor 210-a is double a frame rate for sensor 210-b and may pass two data packets for sensor 210-a to shared ISP 225 for every data packet for sensor 210-b.

In accordance with the described techniques herein, ISP 225 may operate in different contexts based on one or more image statistics 235. For example, image statistics 235-a may be associated with the raw image data from buffer component 215-a while image statistics 235-b may be associated with the raw image data from buffer component 215-b. Examples of operations performed by ISP 225 based on image statistics 235 include an automatic white balance, a black level subtraction, a color correction matrix, and the like. In some cases, image statistics 235 may be determined for an entire image (e.g., a raw image 120 described with reference to FIG. 1), which entire image may then be processed piece-wise (e.g., line-by-line) by ISP 225. In some examples, processing the image by ISP 225 may include operating on pixel values using respective registers 230 (e.g., such that register 230-a may correspond to buffer component 215-a while register 230-b may correspond to buffer component 215-b). That is, each register 230 may represent a quickly accessible location available to ISP 225 (e.g., an amount of fast storage that may be used to perform operations on data packets received from arbitration component 220). In some cases, the image statistics 235 may be fed to ISP 225 based at least in part on the arbitration scheme used by arbitration component 220.

In accordance with the described techniques, ISP 225 may be configured with different back-end contexts (e.g., according to or based on image statistics 235) such that dynamic switching between processing conditions may be achieved with little or no delay (e.g., which may support low latency operations or provide other such benefits). Such dynamic switching may be realized by the hardware associated with ISP 225 (e.g., based at least in part on the use of multiple registers 230), which may provide faster switching than may be possible using software.

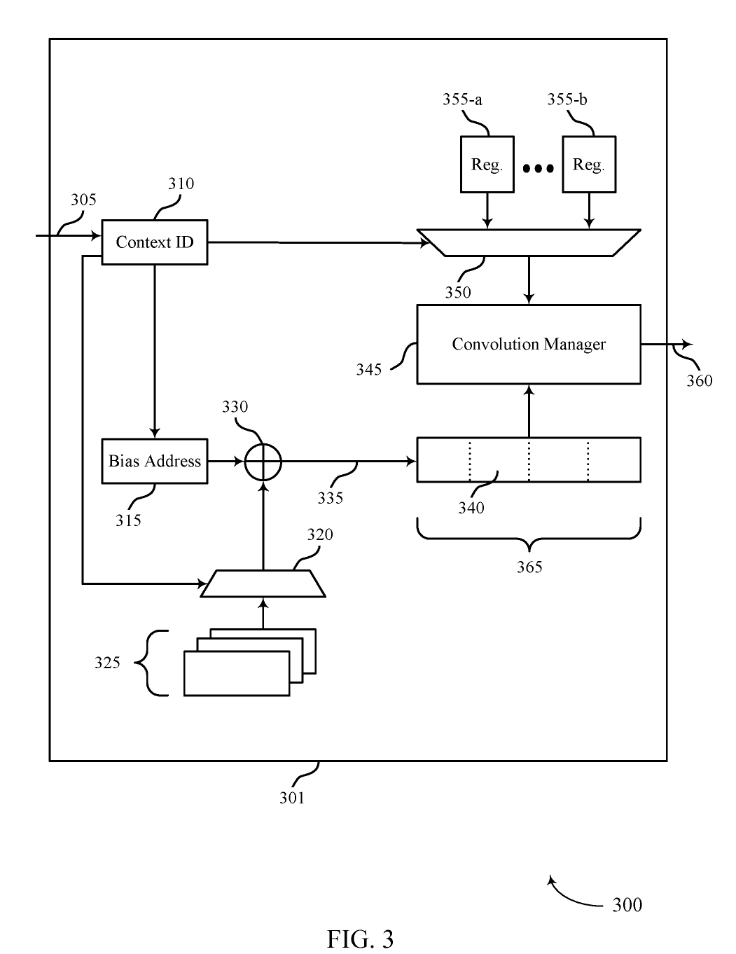

FIG. 3 illustrates an example of a process flow 300 that supports multi-context real time inline image signal processing in accordance with aspects of the present disclosure. For example, process flow 300 may illustrate aspects of operations of an ISP 301 (e.g., which may be an example of the corresponding component described with reference to FIG. 2).

At 305, ISP 301 may receive an input (e.g., from an arbitration component). For example, the input may include one or more data packets, where each data packet may be associated with a given image frame or portion thereof (e.g., one or more lines of pixels of a given image frame).

At 310, ISP 301 may determine a context identifier associated with the input data packet(s). For example, the context identifier may be contained in a data field (e.g., or a header) of the data packet. The context identifier may represent a field used by ISP 301 to track a given line of pixels (e.g., or a given data packet) as it is processed through ISP 301. For example, the context identifier may control the contents and/or configuration of a line buffer 365 as well as the selection of a register 355.

At 315, ISP 301 may determine an address, such as a bias address, based on the context identifier. For example, the bias address may correspond to a given row of pixels within a given image. Similarly, at 320, ISP 301 may determine a second address (e.g., corresponding to a given column of pixels) based on the context identifier and at least one of a plurality of counters 325. At 330, ISP 301 may determine a third address (e.g., a pixel address) based on the bias address and the second address. The bias address, second address, and third address may refer to pixel rows, pixel columns, and specific pixels (respectively) within a given image array. Thus, in some cases, the bias address, second address, and third address may be used in conjunction with (e.g., and depend upon) the context identifier for tracking image data through ISP 301.

At 335, the third address (e.g., a pixel address) may be fed to a shared line buffer 365, which may have a plurality of partitions 340 in some cases. For example, shared line buffer 365 may support multiple imaging contexts through configurable allocation of partitions 340. That is, one or more partitions 340 may be assigned to pixels (e.g., or lines of pixels) associated with one or more respective buffer components to allow configurable line buffer sharing for multiple sensors. Such configurable line buffer 365 sharing may support flexible multi-context real time inline image signal processing in accordance with aspects of the present disclosure. Configurable sharing of line buffer 365 (e.g., which may account for 30% of the area of ISP 301 in some implementations) may improve the flexibility of the described techniques herein.

At 350, ISP 301 may select one of a plurality of registers 355 based on the context identifier from 310. At 345, a convolution manager of ISP 301 may perform an operation (e.g., a channel location convolution or some other image processing operation) using the register selected at 350 and the line buffer 365 configured at 335. At 360, ISP 301 may output a result of the convolution operation (e.g., to a display buffer, to a system memory, to a transmit buffer).

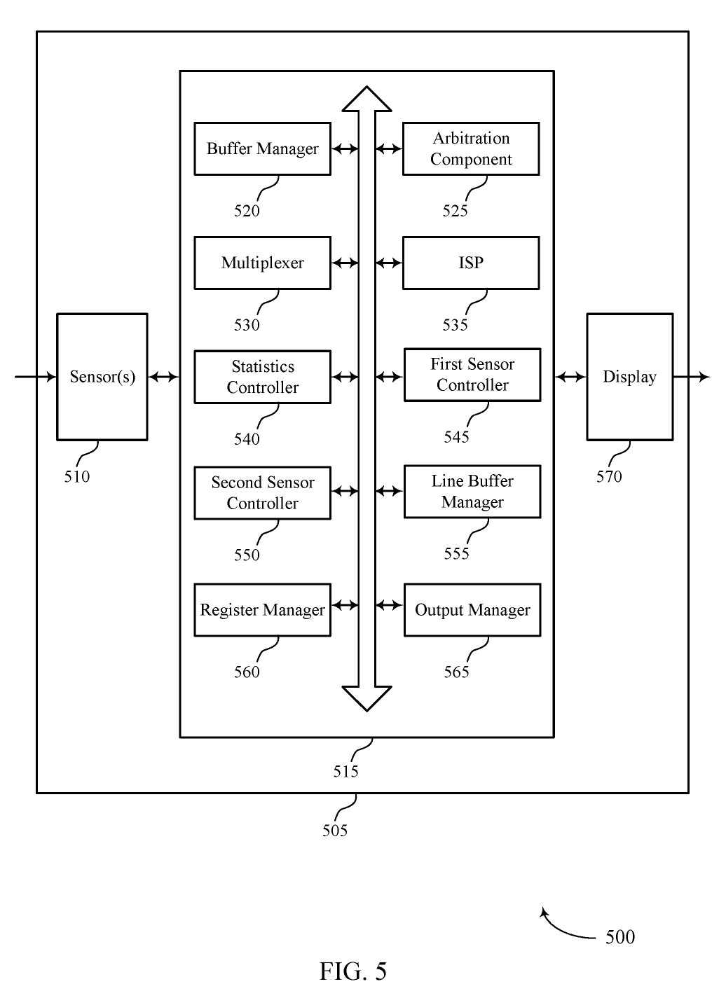

FIG. 4 illustrates an example of a timing diagram 400 that supports multi-context real time inline image signal processing in accordance with aspects of the present disclosure. Aspects of timing diagram 400 may relate to operations of an arbitration component as described herein (e.g., with reference to FIGS. 2 and 5).

A first sensor 430-a may capture a first set of image data 405 (e.g., which may comprise a plurality of pixel lines 410-a and one or more vertical blanks (VBLKs)). Similarly, a second sensor 430-b may capture a second set of image data 415 (e.g., which may comprise a plurality of pixel lines 410-b). In some examples, an imaging condition of sensor 430-a may differ from an imaging condition of sensor 430-b (e.g., such that pixel lines 410-a may be associated with different time durations than pixel lines 410-b). In accordance with the described techniques, an arbitration component may multiplex the first set of image data 405 and the second set of image data 415 into a set of data packets 420, which may be fed to a shared ISP (e.g., as described with reference to FIG. 2). For example, the set of data packets 420 may include a first data packet 425-a which contains two pixel lines 410-a and a second data packet 425-b which contains two pixel lines 410-b. The multiplexing scheme used for the set of data packets 420 may in some cases depend on an arbitration metric associated with one or more of sensors 430-a and 430-b (e.g., a latency metric, a frame rate, a resolution, etc.). As an example, an arbitration component may determine that a frame rate for sensor 430-a is different from (e.g., greater than, double) a frame rate for sensor 430-b and may pass a different number of (e.g., two) data packets for sensor 430-a to a shared ISP for a first number (e.g., one data packet, every data packet) for sensor 430-b. Additionally or alternatively, the arbitration component may consider a latency metric (e.g., a latency tolerance) for each sensor 430. For example, if sensor 430-a is associated with the operations of a device (e.g., safety operations) while sensor 430-b is associated with recreational images (e.g., landscapes, panoramas, etc.), the arbitration scheme may prioritize image data from sensor 430-a. Additionally or alternatively, the arbitration component may consider an amount of data associated with each sensor 430 (e.g., in terms of a resolution of an image for each sensor 430) in mediating packet input to the shared ISP.

Timing diagram 400 may support operations in which the pixel lines 410 received from different sensors 430 may not be synchronized (e.g., such that the timing of sensors 430 operating in accordance with timing diagram 400 may be arbitrary). That is, timing diagram 400 may support operations in which the sizes of images associated with different sensors 430 are not the same, operations in which the frame rates between different sensors 430 are not the same, other aspects differ, or some combination.

The described techniques may thus provide for multi-context image signal processing in consideration of operational and manufacturing constraints, which may improve the performance of a device in terms of image quality, processing requirements, size, and the like. In accordance with the techniques described herein, an ISP may be dynamically configured to support multiple sensors (e.g., through the use of multiple registers, image statistics, and related operational considerations as described with reference to FIGS. 2 and 3). The described techniques may provide benefits associated with having multiple independent ISP engines each associated with one of a plurality of sensors (e.g., benefits including improved image quality and low latency) without the need to fit a large number of ISP engines on a single SoC.

For example, the low latency may be provided based on an arbitration scheme (e.g., as illustrated with reference to FIG. 4). The improved image quality (e.g., relative to feeding the outputs from a plurality of sensors to a single-context ISP) may be achieved through the use of multiple registers, multiple image statistics storages, and context identifiers which allow for tracking of such registers and image statistics for a given pixel (e.g., or line of pixels) that is to be processed by the shared ISP.

FIG. 5 shows a block diagram 500 of a device 505 that supports multi-context real time inline image signal processing in accordance with aspects of the present disclosure. The device 505 may include sensor(s) 510, an image processing controller 515, and display 570. Each of these components may be in communication with one another (e.g., via one or more buses).

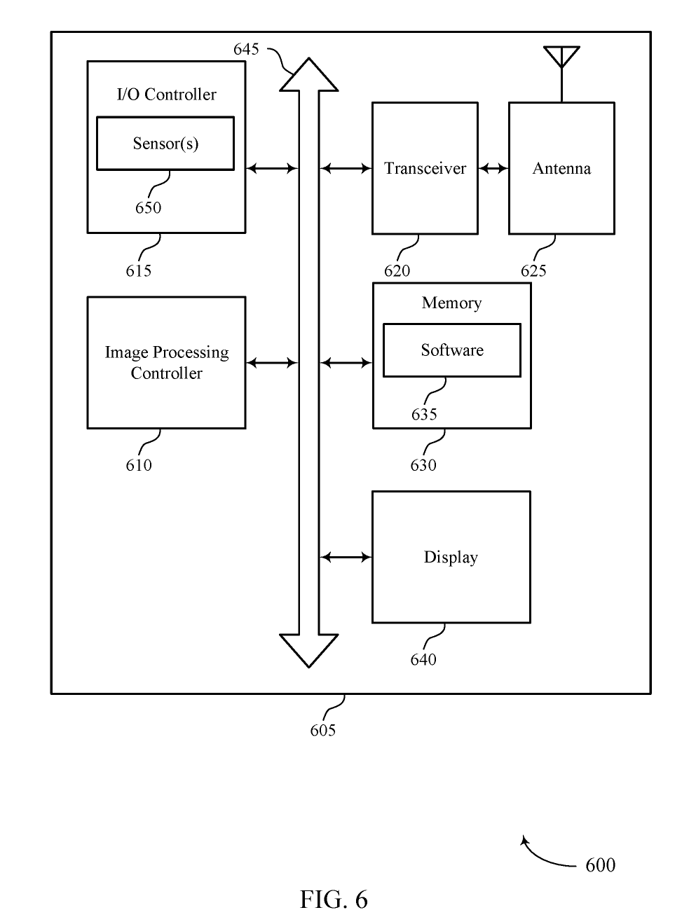

Sensor 510 may include or be an example of a digital imaging sensor for taking photos and video. In some examples, sensor 510 may receive information such as packets, user data, or control information associated with various information channels (e.g., from a transceiver 620 described with reference to FIG. 6). Information may be passed on to other components of the device. Additionally or alternatively, components of device 505 used to communicate data over a wireless (e.g., or wired) link may be in communication with image processing controller 515 (e.g., via one or more buses) without passing information through sensor 510. In some cases, sensor 510 may represent a single physical sensor that is capable of operating in a plurality of imaging modes. Additionally or alternatively, sensor 510 may represent an array of sensors (e.g., where each sensor may be capable of operating in one or more imaging modes). The sensor 510 (e.g., or array of sensors 510) may capture a plurality of images, where each sensor 510 (e.g., or each mode of a given sensor 510) is associated with a respective buffer component of a set of buffer components of device 505.

Image processing controller 515 may be an example of aspects of the image processing controller 610 described with reference to FIG. 6. The image processing controller 515, or its sub-components, may be implemented in hardware, code (e.g., software or firmware) executed by a processor, or any combination thereof. If implemented in code executed by a processor, the functions of the image processing controller 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The image processing controller 515, or its sub-components, may be physically located at various positions, including being distributed such that portions of functions are implemented at different physical locations by one or more physical components. In some examples, the image processing controller 515, or its sub-components, may be a separate and distinct component in accordance with various aspects of the present disclosure. In some examples, the image processing controller 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The image processing controller 515 may include a buffer manager 520, an arbitration component 525, a multiplexer 530, an ISP 535, a statistics controller 540, a first sensor controller 545, a second sensor controller 550, a line buffer manager 555, a register manager 560, and an output manager 565. Each of these modules may communicate, directly or indirectly, with one another (e.g., via one or more buses).

The buffer manager 520 may receive, at each of a set of buffer components of device 505, respective sets of pixel lines, where each set of pixel lines is associated with a respective raw image. Thus, in some examples buffer manager 520 may represent a controller for a plurality of buffer components, each associated with a respective sensor 510 (e.g., or a respective mode of a given sensor 510).

The arbitration component 525 may combine each set of pixel lines into one or more data packets. In some examples, the arbitration component 525 may determine an arbitration metric for passing the one or more data packets to a shared ISP (e.g., ISP 535), where the arbitration metric includes a latency metric for each respective raw image, a size of each respective raw image, an imaging condition for each respective raw image, a buffer component size for each respective raw image, a resolution for each respective raw image, or a combination thereof. In some examples, the arbitration component 525 may determine an arbitration scheme for the one or more data packets based on the arbitration metric, where using the time division multiplexing scheme includes implementing the arbitration scheme for the one or more data packets.

The multiplexer 530 may pass, using a time division multiplexing scheme, the one or more data packets from the arbitration component to a shared ISP of device 505 (e.g., ISP 535).

ISP 535 may generate a respective processed image for each raw image based on the one or more data packets. In some examples, the ISP 535 may update one or more image processing parameters for each data packet associated with a given raw image, where generating the respective processed image for each raw image is based on the updated one or more image processing parameters.

The statistics controller 540 may determine one or more image statistics for each raw image. In some examples, the statistics controller 540 may pass the one or more image statistics to the shared ISP based on the time division multiplexing scheme. Example image statistics include an automatic white balance, a black level subtraction, a color correction matrix, a pixel saturation metric, an image resolution, and the like. In some cases, statistics controller 540 may determine the image statistics for the entire raw image (e.g., based on all pixel values in the raw image), which pixel values may then be processed incrementally (e.g., line-by-line) by ISP 535 in accordance with the time division multiplexing scheme.

The first sensor controller 545 may identify a first imaging condition associated with a first sensor mode. In some examples, the first sensor controller 545 may capture a first raw image at a first sensor 510 using the first sensor mode based on the first imaging condition, where a first buffer component of the set of buffer components is associated with the first sensor 510.

The second sensor controller 550 may identify a second imaging context associated with a second sensor mode. In some examples, the second sensor controller 550 may capture a second raw image at a second sensor 510 using the second sensor mode, where a second buffer component of the set of buffer components is associated with the second sensor 510. In some cases, the first imaging condition and the second imaging condition each include one or more of a lighting condition, a focal length, a frame rate, an aperture width, or a combination thereof. In some cases, the first sensor 510 and the second sensor 510 include a same sensor 510 of device 505, the same sensor 510 configured to capture the first raw image using the first sensor mode at a first time based on the first imaging condition and configured to capture the second raw image using the second sensor mode at a second time based on the second imaging condition. Thus, in some cases first sensor controller 545 and second sensor controller 550 may represent a same component of device 505.

The line buffer manager 555 may identify a pixel throughput limit for a line buffer of ISP 535. In some examples, the line buffer manager 555 may determine a respective pixel performance metric for each sensor 510 of a set of sensors 510 coupled with device 505. In some examples, the line buffer manager 555 may configure a space allocation of the line buffer based on the pixel performance metrics, a number of sensors in the set of sensors, or a combination thereof. In some examples, the line buffer manager 555 may allocate respective subspaces of the line buffer the one or more data packets from the arbitration component 525 based on the pixel performance metrics.

The register manager 560 may update values of a respective register for each of the set of buffer components, where the respective processed image for each raw image is generated based on the updated values of the respective register.

In some examples, the output manager 565 may write at least one processed image to a memory of device 505. In some examples, the output manager 565 may transmit the at least one processed image to a second device. In some examples, the output manager 565 may display the at least one processed image (e.g., via display 570). In some examples, the output manager 565 may update an operating parameter of device 505 based on the at least one processed image.

Display 570 may be a touchscreen, a light emitting diode (LED), a monitor, etc. In some cases, display 570 may be replaced by system memory. That is, in some cases in addition to (or instead of) being displayed by device 505, the processed image may be stored in a memory of device 505.

FIG. 6 shows a diagram of a system 600 including a device 605 that supports multi-context real time inline image signal processing in accordance with aspects of the present disclosure. Device 605 may be an example of or include the components of device 505. Device 605 may include components for bi-directional voice and data communications including components for transmitting and receiving communications. Device 605 may include image processing controller 610, I/O controller 615, transceiver 620, antenna 625, memory 630, and display 640. These components may be in electronic communication via one or more buses (e.g., bus 645).

Image processing controller 610 may include an intelligent hardware device, (e.g., a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a programmable logic device, a discrete gate or transistor logic component, a discrete hardware component, or any combination thereof). In some cases, image processing controller 610 may be configured to operate a memory array using a memory controller. In other cases, a memory controller may be integrated into image processing controller 610. Image processing controller 610 may be configured to execute computer-readable instructions stored in a memory to perform various functions (e.g., functions or tasks supporting face tone color enhancement).

I/O controller 615 may manage input and output signals for device 605. I/O controller 615 may also manage peripherals not integrated into device 605. In some cases, I/O controller 615 may represent a physical connection or port to an external peripheral. In some cases, I/O controller 615 may utilize an operating system such as iOS®, ANDROID®, MS-DOS®, MS-WINDOWS®, OS/2®, UNIX®, LINUX®, or another known operating system. In other cases, I/O controller 615 may represent or interact with a modem, a keyboard, a mouse, a touchscreen, or a similar device. In some cases, I/O controller 615 may be implemented as part of a processor. In some cases, a user may interact with device 605 via I/O controller 615 or via hardware components controlled by I/O controller 615. In some cases, I/O controller 615 may be or include sensor 650. Sensor 650 may be an example of a digital imaging sensor for taking photos and video. For example, sensor 650 may represent a camera operable to obtain a raw image of a scene, which raw image may be processed by image processing controller 610 according to aspects of the present disclosure.

Transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas. In some cases, the wireless device may include a single antenna 625. However, in some cases the device may have more than one antenna 625, which may be capable of concurrently transmitting or receiving multiple wireless transmissions.

Device 605 may participate in a wireless communications system (e.g., may be an example of a mobile device). A mobile device may also be referred to as a UE, a wireless device, a remote device, a handheld device, or a subscriber device, or some other suitable terminology, where the “device” may also be referred to as a unit, a station, a terminal, or a client. A mobile device may be a personal electronic device such as a cellular phone, a PDA, a tablet computer, a laptop computer, or a personal computer. In some examples, a mobile device may also refer to a WLL station, an IoT device, an IoE device, a MTC device, or the like, which may be implemented in various articles such as appliances, vehicles, meters, or the like.

Memory 630 may comprise one or more computer-readable storage media. Examples of memory 630 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. Memory 630 may store program modules and/or instructions that are accessible for execution by image processing controller 610. That is, memory 630 may store computer-readable, computer-executable software 635 including instructions that, when executed, cause the processor to perform various functions described herein. In some cases, the memory 630 may contain, among other things, a basic input/output system (BIOS) which may control basic hardware or software operation such as the interaction with peripheral components or devices. The software 635 may include code to implement aspects of the present disclosure, including code to support multi-context real time inline image signal processing. Software 635 may be stored in a non-transitory computer-readable medium such as system memory or other memory. In some cases, the software 635 may not be directly executable by the processor but may cause a computer (e.g., when compiled and executed) to perform functions described herein.

Display 640 represents a unit capable of displaying video, images, text or any other type of data for consumption by a viewer. Display 640 may include a liquid-crystal display (LCD), a LED display, an organic LED (OLED), an active-matrix OLED (AMOLED), or the like. In some cases, display 640 and I/O controller 615 may be or represent aspects of a same component (e.g., a touchscreen) of device 605.

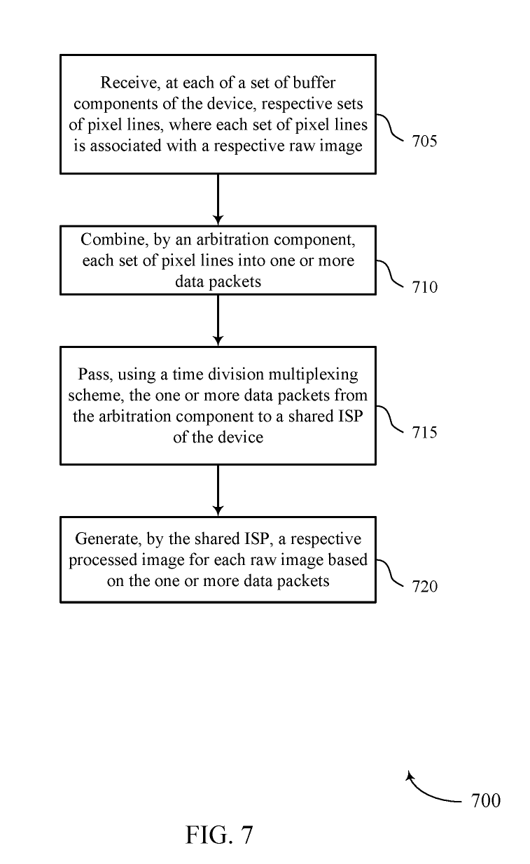

FIG. 7 shows a flowchart illustrating a method 700 that supports multi-context real time inline image signal processing in accordance with aspects of the present disclosure. The operations of method 700 may be implemented by a device or its components as described herein. For example, the operations of method 700 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 705, the device may receive, at each of a plurality of buffer components of the device, respective sets of pixel lines, wherein each set of pixel lines is associated with a respective raw image. The operations of 705 may be performed according to the methods described herein. In some examples, aspects of the operations of 705 may be performed by a buffer manager as described with reference to FIG. 5.

At 710, the device may combine each set of pixel lines into one or more data packets. The operations of 710 may be performed according to the methods described herein. In some examples, aspects of the operations of 710 may be performed by an arbitration component as described with reference to FIG. 5.

At 715, the device may pass, using a time division multiplexing scheme, the one or more data packets from the arbitration component to a shared ISP of the device. The operations of 715 may be performed according to the methods described herein. In some examples, aspects of the operations of 715 may be performed by a multiplexer as described with reference to FIG. 5.

At 720, the device may generate a respective processed image for each raw image based at least in part on the one or more data packets. The operations of 720 may be performed according to the methods described herein. In some examples, aspects of the operations of 720 may be performed by an ISP as described with reference to FIG. 5.

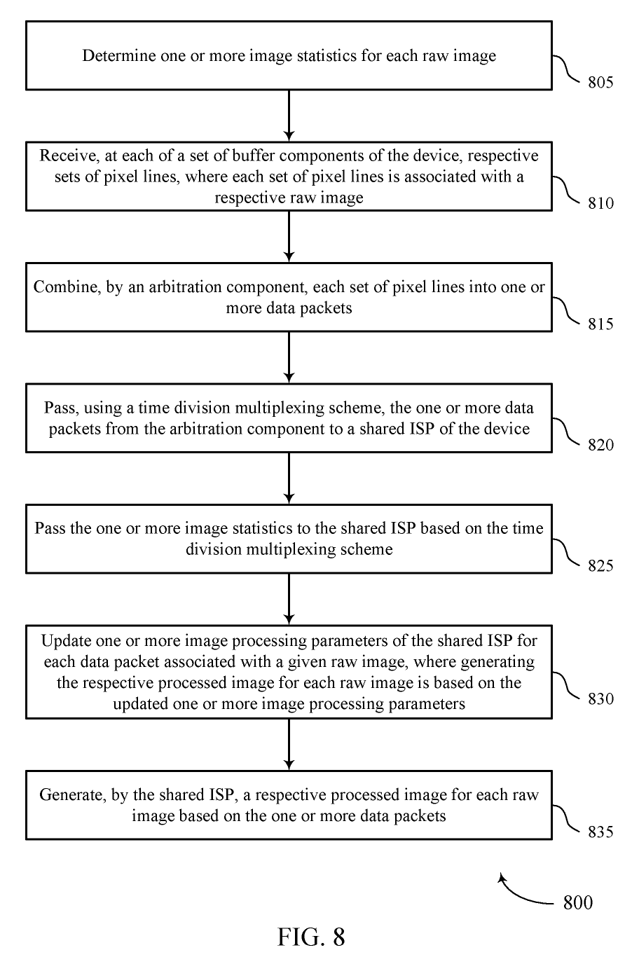

FIG. 8 shows a flowchart illustrating a method 800 that supports multi-context real time inline image signal processing in accordance with aspects of the present disclosure. The operations of method 800 may be implemented by a device or its components as described herein. For example, the operations of method 800 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 805, the device may determine one or more image statistics for each raw image. The operations of 805 may be performed according to the methods described herein. In some examples, aspects of the operations of 805 may be performed by a statistics controller as described with reference to FIG. 5.

At 810, the device may receive, at each of a plurality of buffer components of the device, respective sets of pixel lines, wherein each set of pixel lines is associated with a respective raw image. The operations of 810 may be performed according to the methods described herein. In some examples, aspects of the operations of 810 may be performed by a buffer manager as described with reference to FIG. 5.

At 815, the device may combine each set of pixel lines into one or more data packets. The operations of 815 may be performed according to the methods described herein. In some examples, aspects of the operations of 815 may be performed by an arbitration component as described with reference to FIG. 5.

At 820, the device may pass, using a time division multiplexing scheme, the one or more data packets from the arbitration component to a shared ISP of the device. The operations of 820 may be performed according to the methods described herein. In some examples, aspects of the operations of 820 may be performed by a multiplexer as described with reference to FIG. 5.

At 825, the device may pass the one or more image statistics to the shared ISP based at least in part on the time division multiplexing scheme. The operations of 825 may be performed according to the methods described herein. In some examples, aspects of the operations of 825 may be performed by a statistics controller as described with reference to FIG. 5.

At 830, the device may update one or more image processing parameters of the shared ISP for each data packet associated with a given raw image, wherein generating the respective processed image for each raw image is based at least in part on the updated one or more image processing parameters. The operations of 830 may be performed according to the methods described herein. In some examples, aspects of the operations of 830 may be performed by an ISP as described with reference to FIG. 5.

At 835, the device may generate a respective processed image for each raw image based at least in part on the one or more data packets. The operations of 835 may be performed according to the methods described herein. In some examples, aspects of the operations of 835 may be performed by an ISP as described with reference to FIG. 5.

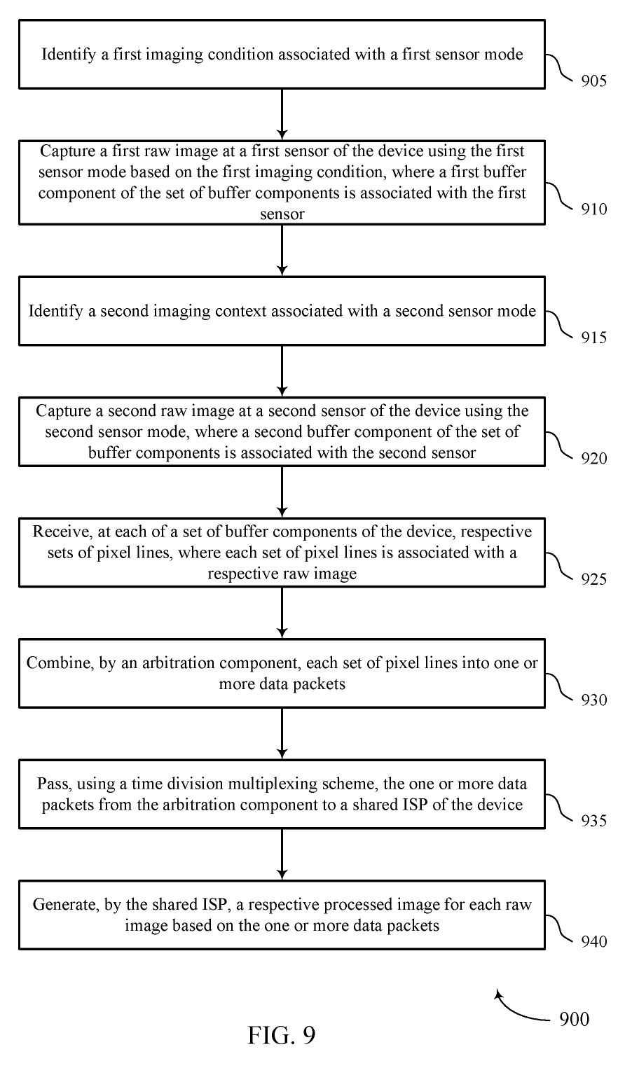

FIG. 9 shows a flowchart illustrating a method 900 that supports multi-context real time inline image signal processing in accordance with aspects of the present disclosure. The operations of method 900 may be implemented by a device or its components as described herein. For example, the operations of method 900 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 905, the device may identify a first imaging condition associated with a first sensor mode. The operations of 905 may be performed according to the methods described herein. In some examples, aspects of the operations of 905 may be performed by a first sensor controller as described with reference to FIG. 5.

At 910, the device may capture a first raw image at a first sensor of the device using the first sensor mode based at least in part on the first imaging condition, wherein a first buffer component of the plurality of buffer components is associated with the first sensor. The operations of 910 may be performed according to the methods described herein. In some examples, aspects of the operations of 910 may be performed by a first sensor controller as described with reference to FIG. 5.

At 915, the device may identify a second imaging context associated with a second sensor mode. The operations of 915 may be performed according to the methods described herein. In some examples, aspects of the operations of 915 may be performed by a second sensor controller as described with reference to FIG. 5.

At 920, the device may capture a second raw image at a second sensor of the device using the second sensor mode, wherein a second buffer component of the plurality of buffer components is associated with the second sensor. The operations of 920 may be performed according to the methods described herein. In some examples, aspects of the operations of 920 may be performed by a second sensor controller as described with reference to FIG. 5.

At 925, the device may receive, at each of a plurality of buffer components of the device, respective sets of pixel lines, wherein each set of pixel lines is associated with a respective raw image. The operations of 925 may be performed according to the methods described herein. In some examples, aspects of the operations of 925 may be performed by a buffer manager as described with reference to FIG. 5.

At 930, the device may combine each set of pixel lines into one or more data packets. The operations of 930 may be performed according to the methods described herein. In some examples, aspects of the operations of 930 may be performed by an arbitration component as described with reference to FIG. 5.

At 935, the device may pass, using a time division multiplexing scheme, the one or more data packets from the arbitration component to a shared ISP of the device. The operations of 935 may be performed according to the methods described herein. In some examples, aspects of the operations of 935 may be performed by a multiplexer as described with reference to FIG. 5.

At 940, the device may generate a respective processed image for each raw image based at least in part on the one or more data packets. The operations of 940 may be performed according to the methods described herein. In some examples, aspects of the operations of 940 may be performed by an ISP as described with reference to FIG. 5.

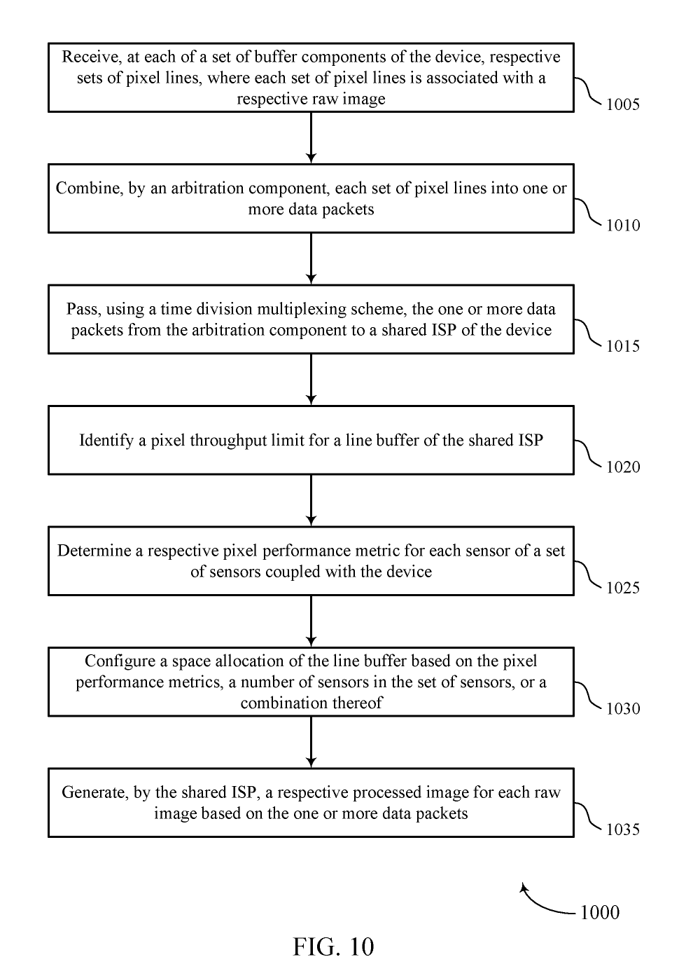

FIG. 10 shows a flowchart illustrating a method 1000 that supports multi-context real time inline image signal processing in accordance with aspects of the present disclosure. The operations of method 1000 may be implemented by a device or its components as described herein. For example, the operations of method 1000 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 1005, the device may receive, at each of a plurality of buffer components of the device, respective sets of pixel lines, wherein each set of pixel lines is associated with a respective raw image. The operations of 1005 may be performed according to the methods described herein. In some examples, aspects of the operations of 1005 may be performed by a buffer manager as described with reference to FIG. 5.

At 1010, the device may combine each set of pixel lines into one or more data packets. The operations of 1010 may be performed according to the methods described herein. In some examples, aspects of the operations of 1010 may be performed by an arbitration component as described with reference to FIG. 5.

At 1015, the device may pass, using a time division multiplexing scheme, the one or more data packets from the arbitration component to a shared ISP of the device. The operations of 1015 may be performed according to the methods described herein. In some examples, aspects of the operations of 1015 may be performed by a multiplexer as described with reference to FIG. 5.

At 1020, the device may identify a pixel throughput limit for a line buffer of the shared ISP. The operations of 1020 may be performed according to the methods described herein. In some examples, aspects of the operations of 1020 may be performed by a line buffer manager as described with reference to FIG. 5.

At 1025, the device may determine a respective pixel performance metric for each sensor of a set of sensors coupled with the device. The operations of 1025 may be performed according to the methods described herein. In some examples, aspects of the operations of 1025 may be performed by a line buffer manager as described with reference to FIG. 5.

At 1030, the device may configure a space allocation of the line buffer based at least in part on the pixel performance metrics, a number of sensors in the set of sensors, or a combination thereof. The operations of 1030 may be performed according to the methods described herein. In some examples, aspects of the operations of 1030 may be performed by a line buffer manager as described with reference to FIG. 5.

At 1035, the device may generate a respective processed image for each raw image based at least in part on the one or more data packets. The operations of 1035 may be performed according to the methods described herein. In some examples, aspects of the operations of 1035 may be performed by an ISP as described with reference to FIG. 5.

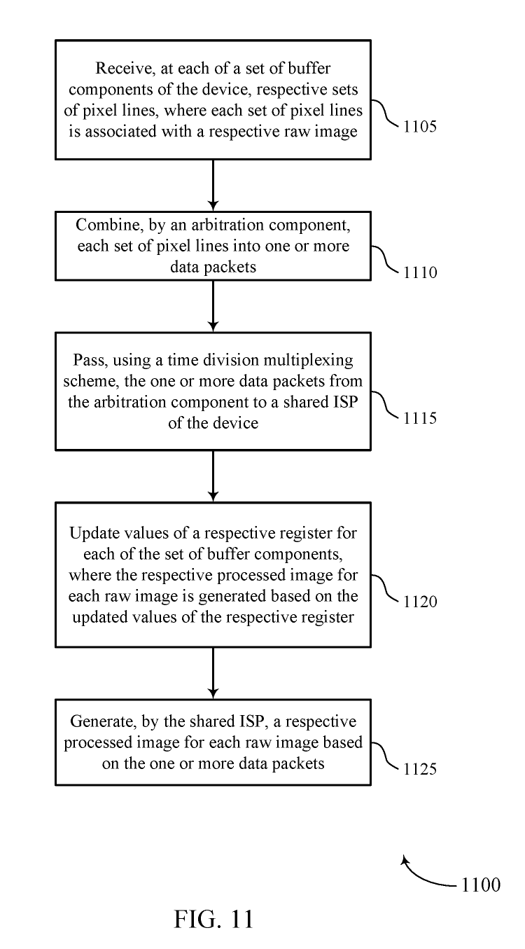

FIG. 11 shows a flowchart illustrating a method 1100 that supports multi-context real time inline image signal processing in accordance with aspects of the present disclosure. The operations of method 1100 may be implemented by a device or its components as described herein. For example, the operations of method 1100 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 1105, the device may receive, at each of a plurality of buffer components of the device, respective sets of pixel lines, wherein each set of pixel lines is associated with a respective raw image. The operations of 1105 may be performed according to the methods described herein. In some examples, aspects of the operations of 1105 may be performed by a buffer manager as described with reference to FIG. 5.

At 1110, the device may combine each set of pixel lines into one or more data packets. The operations of 1110 may be performed according to the methods described herein. In some examples, aspects of the operations of 1110 may be performed by an arbitration component as described with reference to FIG. 5.

At 1115, the device may pass, using a time division multiplexing scheme, the one or more data packets from the arbitration component to a shared ISP of the device. The operations of 1115 may be performed according to the methods described herein. In some examples, aspects of the operations of 1115 may be performed by a multiplexer as described with reference to FIG. 5.

At 1120, the device may update values of a respective register for each of the plurality of buffer components, wherein the respective processed image for each raw image is generated based at least in part on the updated values of the respective register. The operations of 1120 may be performed according to the methods described herein. In some examples, aspects of the operations of 1120 may be performed by a register manager as described with reference to FIG. 5.

At 1125, the device may generate a respective processed image for each raw image based at least in part on the one or more data packets. The operations of 1125 may be performed according to the methods described herein. In some examples, aspects of the operations of 1125 may be performed by an ISP as described with reference to FIG. 5.

It should be noted that the methods described above describe possible implementations, and that the operations and the steps may be rearranged or otherwise modified and that other implementations are possible. Further, aspects from two or more of the methods may be combined. In some cases, one or more operations described above (e.g., with reference to FIGS. 7 through 11) may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
receiving, at each of a plurality of buffer components of the device, respective sets of pixel lines, wherein each set of pixel lines is associated with a respective raw image;
combining, by an arbitration component, each set of pixel lines into one or more data packets;
passing, using a time division multiplexing scheme, the one or more data packets from the arbitration component to a shared image signal processor (ISP) of the device; and
generating, by the shared ISP, a respective processed image for each raw image based at least in part on the one or more data packets.

2. The method of claim 1, further comprising:
determining an arbitration metric for passing the one or more data packets to the shared ISP, wherein the arbitration metric comprises a latency metric for each respective raw image, a size of each respective raw image, an imaging condition for each respective raw image, a buffer component size for each respective raw image, a resolution for each respective raw image, or a combination thereof; and
determining an arbitration scheme for the one or more data packets based at least in part on the arbitration metric, wherein using the time division multiplexing scheme comprises implementing the arbitration scheme for the one or more data packets.

3. The method of claim 1, further comprising:
determining one or more image statistics for each raw image;
passing the one or more image statistics to the shared ISP based at least in part on the time division multiplexing scheme; and
updating one or more image processing parameters of the shared ISP for each data packet associated with a given raw image, wherein generating the respective processed image for each raw image is based at least in part on the updated one or more image processing parameters.

4. The method of claim 1, further comprising:
capturing each raw image at a respective sensor of the device, wherein each sensor is associated with a respective buffer component of the plurality of buffer components.

5. The method of claim 1, further comprising:
identifying a first imaging condition associated with a first sensor mode;
capturing a first raw image at a first sensor of the device using the first sensor mode based at least in part on the first imaging condition, wherein a first buffer component of the plurality of buffer components is associated with the first sensor;
identifying a second imaging context associated with a second sensor mode; and
capturing a second raw image at a second sensor of the device using the second sensor mode, wherein a second buffer component of the plurality of buffer components is associated with the second sensor.

6. The method of claim 5, wherein the first sensor and the second sensor comprise a same sensor of the device, the same sensor configured to capture the first raw image using the first sensor mode at a first time based at least in part on the first imaging condition and configured to capture the second raw image using the second sensor mode at a second time based at least in part on the second imaging condition.

7. The method of claim 5, wherein the first imaging condition and the second imaging condition each comprise one or more of a lighting condition, a focal length, a frame rate, an aperture width, or a combination thereof.

8. The method of claim 1, further comprising:
identifying a pixel throughput limit for a line buffer of the shared ISP;
determining a respective pixel performance metric for each sensor of a set of sensors coupled with the device; and
configuring a space allocation of the line buffer based at least in part on the pixel performance metrics, a number of sensors in the set of sensors, or a combination thereof.

9. The method of claim 8, wherein configuring the space allocation of the line buffer of the shared ISP comprises:
allocating respective subspaces of the line buffer the one or more data packets from the arbitration component based at least in part on the pixel performance metrics.

10. The method of claim 1, further comprising:
updating values of a respective register for each of the plurality of buffer components, wherein the respective processed image for each raw image is generated based at least in part on the updated values of the respective register.

11. The method of claim 1, further comprising:
writing at least one processed image to a memory of the device;
transmitting the at least one processed image to a second device;
displaying the at least one processed image; or
updating an operating parameter of the device based at least in part on the at least one processed image.

12. An apparatus for image processing, comprising:
a processor,
memory in electronic communication with the processor; and
instructions stored in the memory and executable by the processor to cause the apparatus to:
receive, at each of a plurality of buffer components of the apparatus, respective sets of pixel lines, wherein each set of pixel lines is associated with a respective raw image;
combine, by an arbitration component, each set of pixel lines into one or more data packets;
pass, using a time division multiplexing scheme, the one or more data packets from the arbitration component to a shared image signal processor (ISP) of the apparatus; and
generate, by the shared ISP, a respective processed image for each raw image based at least in part on the one or more data packets.

13. The apparatus of claim 12, wherein the instructions are further executable by the processor to cause the apparatus to:
determine an arbitration metric for passing the one or more data packets to the shared ISP, wherein the arbitration metric comprises a latency metric for each respective raw image, a size of each respective raw image, an imaging condition for each respective raw image, a buffer component size for each respective raw image, a resolution for each respective raw image, or a combination thereof; and
determine an arbitration scheme for the one or more data packets based at least in part on the arbitration metric, wherein using the time division multiplexing scheme are executable by the processor to cause the apparatus to implement the arbitration scheme for the one or more data packets.

14. The apparatus of claim 12, wherein the instructions are further executable by the processor to cause the apparatus to:
determine one or more image statistics for each raw image;
pass the one or more image statistics to the shared ISP based at least in part on the time division multiplexing scheme; and
update one or more image processing parameters of the shared ISP for each data packet associated with a given raw image, wherein generating the respective processed image for each raw image is based at least in part on the updated one or more image processing parameters.

15. The apparatus of claim 12, wherein the instructions are further executable by the processor to cause the apparatus to:
identify a first imaging condition associated with a first sensor mode;
capture a first raw image at a first sensor of the apparatus using the first sensor mode based at least in part on the first imaging condition, wherein a first buffer component of the plurality of buffer components is associated with the first sensor;
identify a second imaging context associated with a second sensor mode; and
capture a second raw image at a second sensor of the apparatus using the second sensor mode, wherein a second buffer component of the plurality of buffer components is associated with the second sensor.

16. The apparatus of claim 12, wherein the instructions are further executable by the processor to cause the apparatus to:
identify a pixel throughput limit for a line buffer of the shared ISP;
determine a respective pixel performance metric for each sensor of a set of sensors coupled with the apparatus; and
configure a space allocation of the line buffer based at least in part on the pixel performance metrics, a number of sensors in the set of sensors, or a combination thereof.

17. The apparatus of claim 12, wherein the instructions are further executable by the processor to cause the apparatus to:
update values of a respective register for each of the plurality of buffer components, wherein the respective processed image for each raw image is generated based at least in part on the updated values of the respective register.

18. An apparatus for image processing, comprising:
means for receiving, at each of a plurality of buffer components of the apparatus, respective sets of pixel lines, wherein each set of pixel lines is associated with a respective raw image;
means for combining, by an arbitration component, each set of pixel lines into one or more data packets;
means for passing, using a time division multiplexing scheme, the one or more data packets from the arbitration component to a shared image signal processor (ISP) of the apparatus; and
means for generating, by the shared ISP, a respective processed image for each raw image based at least in part on the one or more data packets.

19. The apparatus of claim 18, further comprising:
means for determining one or more image statistics for each raw image;
means for passing the one or more image statistics to the shared ISP based at least in part on the time division multiplexing scheme; and
means for updating one or more image processing parameters of the shared ISP for each data packet associated with a given raw image, wherein generating the respective processed image for each raw image is based at least in part on the updated one or more image processing parameters.

20. The apparatus of claim 18, further comprising:
means for identifying a pixel throughput limit for a line buffer of the shared ISP;
means for determining a respective pixel performance metric for each sensor of a set of sensors coupled with the apparatus; and
means for configuring a space allocation of the line buffer based at least in part on the pixel performance metrics, a number of sensors in the set of sensors, or a combination thereof.
